(19) United States
(12) Patent Application Publication
(10) Pub. No.: US 2014/0199109 A1
(43) Pub. Date: Jul. 17, 2014

(54) SKEW REDUCTION IN PRINT MEDIA

(71) Applicant: HEWLETT-PACKA DEVELOPMENT COMPANY, L.P., Houston, TX (US)

(72) Inventors: Andrew B. HURWICH, Portland, OR (US); Michael EWE, Camas, WA (US); Justin M. ROMAN, Portland, OR (US)

(73) Assignee: HEWLETT-PACKARD DEVELOPMENT COMPANY, L.P., Houston, TX (US)

(21) Appl. No.: 13/744,096

(22) Filed: Jan. 17, 2013

(51) Int. Cl. B41J 15/16

(52) U.S. Cl. CPC B41J 15/16
USPC 400/618

(57) ABSTRACT

A system for applying back-tension on a print media, including a roll media print mechanism, a roll media spindle to hold a roll of print media thereon, and a servo motor coupled to the roll media spindle. The servo motor is to apply a first level of back-tension on the print media during a media advance that is not associated with printing and to apply a second level of back-tension on the print media during a media advance that is associated with printing. The first level of back tension is greater than the second level of back-tension.

### BACKGROUND

Wide format and roll media printers are used to print images onto rolls of print media. During printing operations for such printers, skew can develop in the print media due to asymmetric forces acting thereon. Skew refers to a situation where the leading edge of the print media is not substantially perpendicular to the line of travel within the printer. Such skew typically results in a printed image which is not aligned with the edges of the paper. Thus, strategies are needed for preventing this skew from occurring as well as eliminating such skew once it has already manifested.

### BRIEF DESCRIPTION OF THE DRAWINGS

For a detailed description of various examples of the invention, reference will now be made to the accompanying drawings in which:

FIG. 1 shows a perspective view of a roll media printer in accordance with the principles disclosed herein;

FIG. 2 shows a schematic side view of a roll of print media being advanced through a printing assembly of a roll media printer in accordance with the principles disclosed herein;

FIG. 3 shows a schematic top view of the roll of print media of FIG. 2 in accordance with the principles disclosed herein;

FIG. 4 shows a method for adjusting the amount of back-tension on a roll of print media in accordance with the principles disclosed herein;

FIG. 5 shows a schematic side view of the roll of print media of FIG. 2 wherein the torque applied by the rewind motor is reversed in direction in accordance with the principles disclosed herein; and

FIG. 6 shows a method of adjusting the amount of back-tension on a roll of print media in accordance with the principles disclosed herein.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical, or wireless electrical connection. Thus, if a first device couples to a second device, that connection may be through a direct mechanical or electrical connection, through an indirect mechanical or electrical connection via other devices and connections, through an optical electrical connection, or through a wireless electrical connection. Additionally, as used herein, the terms “print advance” and “print media advance” refer to any movement or advance of print media within a printer.

### DETAILED DESCRIPTION

The following discussion is directed to various examples of the invention. Although one or more of these examples may be preferred, the examples disclosed should not be interpreted, or otherwise used, as limiting the scope of the disclosure, including the claims. In addition, one skilled in the art will understand that the following description has broad application, and the discussion of any example is meant only to be descriptive of that example, and not intended to intimate that the scope of the disclosure, including the claims, is limited to that example.

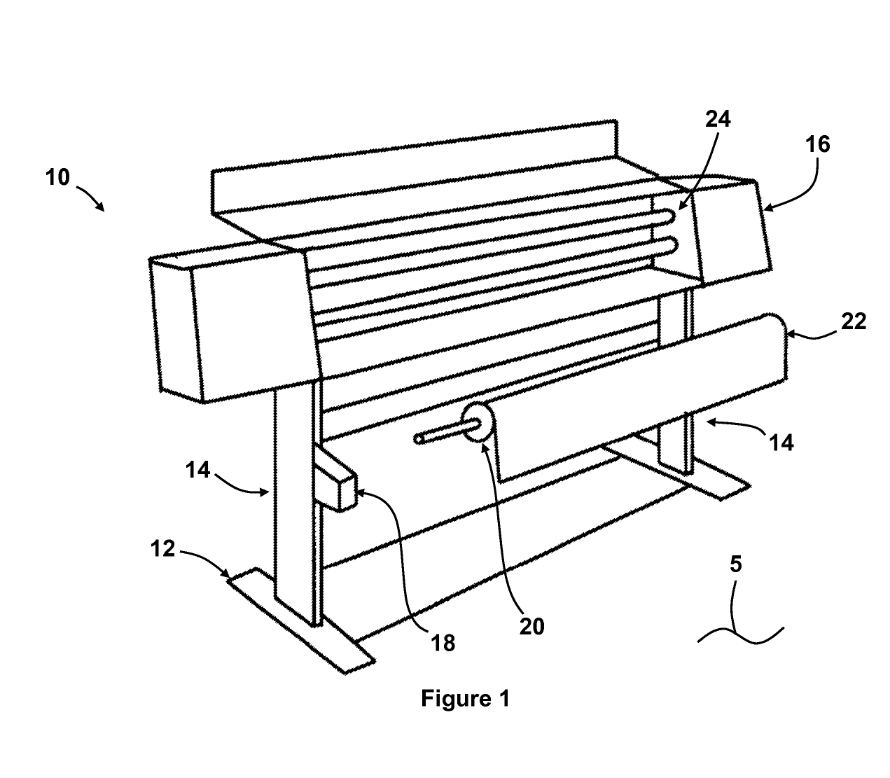

Referring to FIG. 1, wherein an example of a wide format, roll media mechanism or printer 10 is shown. Printer 10 generally comprises a base 12 which supports the printer 10 on a surface 5 (e.g., a floor), a pair of legs 14 which extend upward from the base 12, a printer housing 16 disposed on the legs 14, and a roll media spindle support structure 18 disposed below the housing and arranged to support a roll media spindle assembly 20. In this example, roll media spindle assembly 20 includes a spindle 20a and a roll of print media 22 that is disposed about the roll media spindle 20a. A printing assembly 24 is disposed within the housing 16. As will be described in more detail below, the printing assembly 24 is arranged to advance the print media 22 from the spindle assembly 20 to print images thereon.

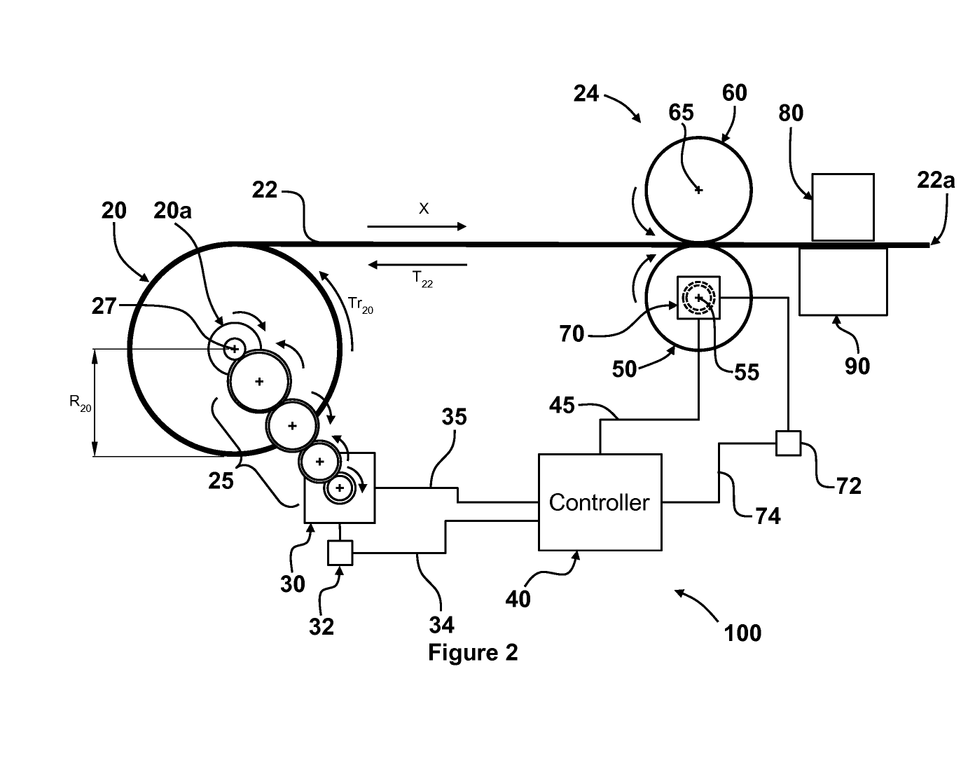

Referring now to FIG. 2, wherein the print media 22 is schematically shown being extracted from the spindle assembly 20 and fed into the printing assembly 24. As is shown in FIG. 2, printing assembly 24 generally comprises a feed roller 50, a pinch roller 60 disposed adjacent the feed roller 50, a print mechanism 80 (e.g., a print-head, a page-wide array, etc. . . . ), and a platen 90. The feed roller 50 has a central axis 55 and is coupled to a first or feed motor 70. The motor 70 is arranged to force the feed roller 50 to rotate about the axis 55. In some examples, the motor 70 is a servo motor. Pinch roller 60 has a central axis 65 that is substantially parallel to and radially adjacent to the axis 55. Further, in the example of FIG. 2, pinch roller 60 is in direct contact with the feed roller 50, such that when the feed roller 50 rotates about the axis 55, the pinch roller 60 is driven to rotate about the axis 65 opposite the direction of rotation of the feed roller 50.

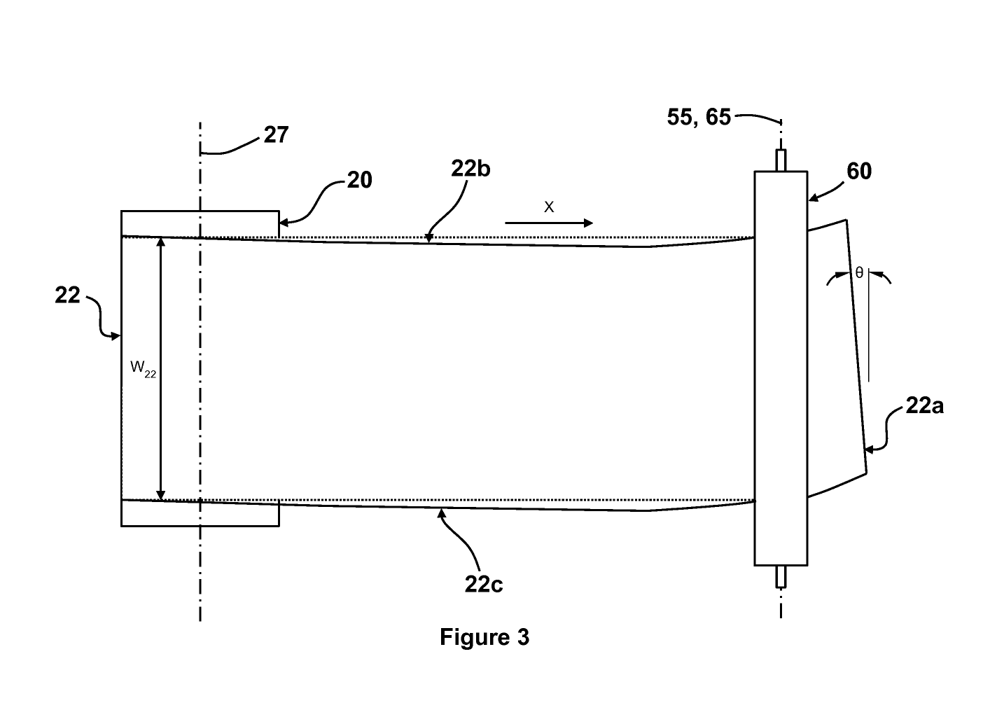

Spindle assembly 20 also has a central longitudinal axis 27 that is substantially parallel to and radially offset from the axes 55 and 65. Print media 22 is substantially disposed on the spindle 20a. Referring briefly to FIG. 3, the print media 22 has a leading edge 22a, a first lateral edge 22b, a second lateral edge 22c opposite the first lateral edge 22b, and a width W₂₂ measured between the first lateral edge 22b and the second lateral edge 22c in a direction that is substantially parallel to the axes 27, 55, and 65. FIG. 2 also illustrates a radius R₂₀ that is measured from the axis 27 of spindle assembly 20 to the radially outermost edge of the print media 22 disposed on the spindle 20a.

Referring still to FIG. 2, a skew reduction system 100 is also shown coupled to the spindle assembly 20 and the printing assembly. In general, the system 100 comprises a second or rewind motor 30, a first encoder 32 coupled to the rewind motor 30, a second encoder 72 coupled to the feed motor 70, and a controller 40 which is electrically coupled to each of the rewind motor 30, the feed motor 70, the first encoder 32, and the second encoder 72.

As is previously described, the rewind motor 30 is coupled to the spindle 20a and is arranged to force the spindle 20a to rotate about the axis 27. In this example, the motor 30 is coupled to the spindle 20a via a gear train 25. However, it should be appreciated that, in other examples, no gear train 25 may be included while still complying with the principles disclosed herein. In some examples, the motor 30 is a servo motor.

In some examples, the controller 40 may be implemented as a hardware device, such as a central processing unit (“CPU”) that executes software. The controller 40 is electrically coupled to both the feed motor 70 and the rewind motor 30 via conductors 45 and 35, respectively, and is arranged to control the torque applied by each of the motors 30, 70. For example, in some implementations, the controller 40 adjusts the torque applied by the motors 30, 70, through pulse-width modulation (PWM) or pulse-duration modulation (PDM).

The encoder 72 is electrically coupled to the feed motor 70 and is further coupled to the controller 40 via a conductor 74. Similarly, the second encoder 32 is electrically coupled to the rewind motor 30 and is further coupled to the controller 40 via a conductor 34. The encoder 72 is arranged to measure values such as, for example, the angular displacement, the angular position, and the angular velocity of the shaft (not shown) of the motor 70 and thus also of the feed roller 50. Similarly, the encoder 32 is arranged to measure values such as, for example, the angular displacement, the angular position, and the angular velocity of the shaft (not shown) of the motor 30 and thus also of the spindle 20a.

Referring now to FIGS. 2 and 3, during printing operations, print media 22 is dispensed from the spindle assembly 20 such that the leading edge 22a is drawn between the feed roller 50 and the pinch roller 60. The feed roller 50 is then driven to rotate via the motor 70 such that the media 22 is advanced in a direction X, toward the print mechanism 80 and platen 90. Specifically, the print media 22 is “pinched” between the feed roller 50 and the pinch roller 60 and is advanced by frictional forces or traction between the feed roller 50, the print media 22, and the pinch roller 60. The print mechanism 80 then prints an image onto the surface of the print media 22.

As is best shown in FIG. 3, during such printing operations, the print media 22 may develop skew such that the leading edge 22a is disposed at an angle θ relative to the axes 55, 65, and 27. This type of skew develops in response to asymmetric forces acting on the print media 22 while it is being dispensed from the spindle assembly 20 and advanced through the printing assembly 24. One strategy for eliminating or preventing this accumulated skew within the print media 22 is to apply tension to the media 22 opposite the direction of advance X. This applied tension may also be referred to as back-tension. As is best shown in FIG. 2, in order to apply back-tension, the controller 40 adjusts the speed of the motor 30, relative to the speed of the motor 70, such that a torque Tr₂₂ is applied to the spindle assembly 20 and a back-tension T₂₂ is applied to the print media 22 itself.

In general, higher amounts of back-tension correspond to less skew formation in the media 22. However, if the back-tension is too high it may overcome the frictional forces between the feed roller 50, the print media 22, and the pinch roller 60, thus causing slipping of the print media 22 and impeding the overall advancement of the print media 22 during printing operations. If such slipping occurs, significant deterioration in the quality of the printed image can occur. Additionally, the optimum or desired amount of back-tension T₂₂ for a given roll of print media 22 may vary greatly depending on a variety of factors including, for example, the type of print advance being completed by the printer 10, the width W₂₂ of the print media itself, the radius R₂₀ of the spindle assembly 20, and the friction or drag within the printer (e.g., printer 10) which opposes the advancement of the print media 22 along the direction X. Thus, examples disclosed herein provide systems and methods for applying and/or adjusting the back-tension (e.g., T₂₂) on the print media (e.g., media 22) while still preserving the quality of the images printed thereon.

Referring again to FIG. 2, in some examples, the amount of tension T₂₂ applied to the print media 22 is determined by the type of print advance being completed. Specifically, in some examples, the amount of tension T₂₂ applied to the print media 22 is adjusted based on whether the print media 22 is being advanced within the printing assembly 24 in order to print an image on the surface thereof, or whether the print media is being advanced for some other purpose, such as, for example, positioning the print media 22 prior to or following a printing job. For print advances of the media 22 in which printing is taking place, a higher level of precision of the position of the print media 22 is required to ensure that the image quality is preserved. Thus, during such advances, the tension T₂₂ is reduced such that the risk of the media slipping on the rollers 50, 60 is also reduced, thereby preserving image quality.

Conversely, advances of the media 22 which are not associated with printing do not require as high a level of precision due to the fact that no printing is taking place. Thus, a certain amount of slippage of the print media 22 within the rollers 50, 60 is acceptable. Therefore, the amount of the tension T₂₂ may be increased during such advances in order to correct any skew which may have accumulated in the print media 22. In some examples, the back-tension T₂₂ applied during non-printing advances may be as high as six times the level of back-tension T₂₂ applied during printing advances. However, it should be appreciated that the difference between the back-tension applied during print advances versus non-printing advances may vary greatly while still complying with the principles disclosed herein.

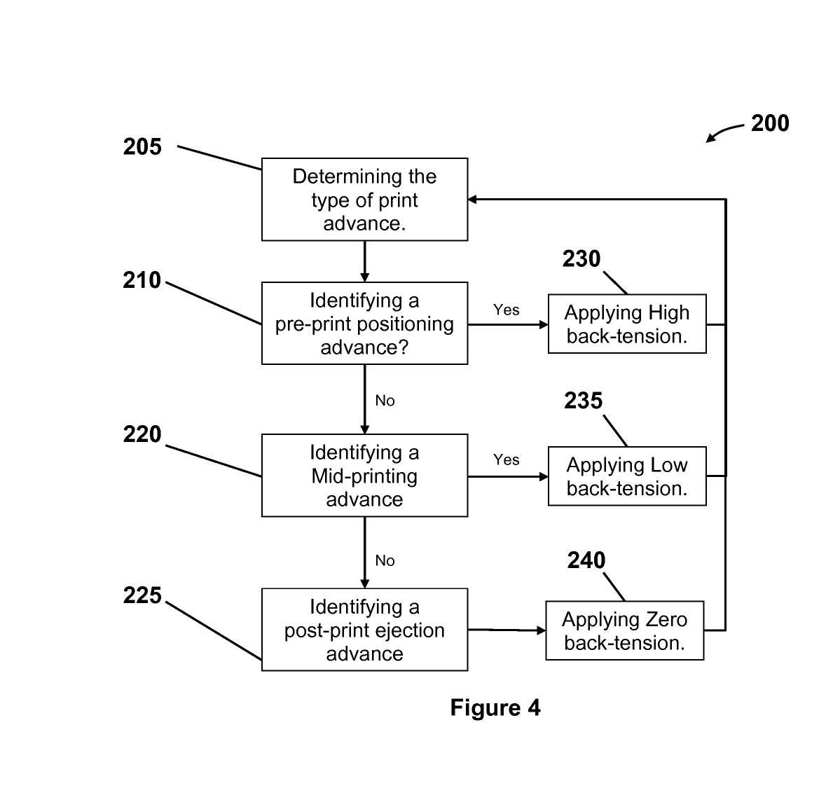

Referring now to FIG. 4, wherein a method 200 for adjusting the back tension (e.g., tension T₂₂) applied to a print media (e.g., media 22) is shown. Though depicted sequentially as a matter of convenience, at least some of the operations shown can be performed in a different order and/or performed in parallel. Further, some embodiments may perform only some of the operations shown. Still further, in some examples, the method 200 may be performed largely by the controller 40.

Initially, the method 200 begins by determining the type of print advance taking place at block 205. Consequently, a first inquiry is made at block 210 as to whether the print advance is a pre-print positioning advance, which occurs prior to the disposition of ink onto the surface of the print media. If “yes” then the controller increases the back-tension applied to the print media (e.g., print media 22) at block 230 in order to correct any skew which may have accumulated within the media. Specifically, the controller increases the torque (e.g., torque Tr₂₂) applied to the spindle (e.g., spindle assembly 20) in order to increase the tension (e.g., tension T₂₂) applied to the print media. If, on the other hand, the answer to the inquiry in block 210 is “no”, thereby indicating that the print advance is not a pre-print positioning advance, a second inquiry is triggered at block 220 as to whether the advance is a mid-printing advance or one that is occurring while ink is being dispensed onto the surface of the print media. If “yes” then the controller decreases the back-tension applied to the print media at block 235 such that the positional precision of the print media is preserved, thus ensuring a high image quality. If, at block 220, the print advance is not a mid-printing advance, then a determination is made at block 225 that the print advance is a post-printing ejection advance wherein the print media is being fed out of the printer (e.g., printer 10) following the completion of a printing operation. Once this determination is made in block 225, the back-tension applied to the print media is reduced to zero or substantially zero in order to allow the print media to be advanced unhindered. Thereafter, the method 200 directs the analysis to begin again at block 205. Thus, through application of the method 200, the level of back-tension (e.g., tension T₂₂) applied to the media 22 is varied or adjusted based on the type of print media advance.

Referring now to FIGS. 2 and 3, as is previously described above, in some examples, the level or amount of the torque Tr₂₂ that is applied by the motor 30 is adjusted based on the radius R₂₀ of the spindle assembly 20. In particular, less torque Tr₂₀ is required to produce a desired level of back-tension T₂₂ for a smaller radius R₂₀, while a higher level of torque Tr₂₀ is required to produce the same desired level of back-tension T₂₂ for a larger radius R₂₀. Thus, as print media 22 is withdrawn from spindle 20a, thereby reducing the radius R₂₀, a decreasing amount of torque Tr₂₀ is required to maintain a constant level of back-tension T₂₂.

The radius R₂₀ may be determined in a variety of manners while still complying with the principles disclosed herein. For example, the radius R₂₀ may be determined by first allowing the feed roller 50 to advance an amount of print media 22. The length of this advanced amount of media 22 is measured by the controller 40 through interpretation of the angular displacement of the motor 70 via the encoder 72. Next, the angular displacement of the spindle 20a which corresponds to the measured angular displacement of the feed roller 50 is also measured by the controller 40. Specifically, the angular displacement of the spindle 20a is measured by interpretation of the signal produced by the encoder 32. For purposes of clarity, the length of print media which is advanced by the feed roller 50 will be referred to herein as L₂₂, while the corresponding angular displacement of the spindle 20a will be referred to herein as α₂₀ (wherein α₂₀ may be measured in radians). These measured values allow the controller 40 to then calculate the radius R₂₀ of the spindle assembly 20, in order to determine the level of torque Tr₂₀ to apply via the motor 30 to produce the desired level of back-tension T₂₂. Specifically, in some examples, the controller 40 contains software which relates values of the radius R₂₀ to corresponding values of torque Tr₂₀. Thus, once the radius R₂₀ is determined via the methods described herein, the controller 40 directs the motor 30 to apply a torque load Tr₂₀ that corresponds to the calculated radius R₂₀. In some examples, the values of torque Tr₂₀ which correspond to given values of the radius R₂₀ are experimentally determined. In some examples, the radius R₂₀ of the spindle assembly 20 is continuously measured throughout the printing process. In some examples, the radius R₂₀ is calculated according to the following mathematical relationship:

$${R}_{20} = \frac{{L}_{22}}{{α}_{20}} .$$

Referring still to FIGS. 2 and 3, as is previously described above, in some examples, the level or amount of torque Tr₂₀ applied by the motor 30 may be adjusted based on the width W₂₂ of the print media itself. In particular, when the width W₂₂ of the print media 22 is reduced, the surface area of the media 22 in contact with the feed roller 50 and pinch roller 60 is reduced, thereby also resulting in a reduction of the frictional forces between the media 22 and the rollers 50 and 60. This reduction in the frictional forces necessitates the lowering of the applied back tension T₂₂ in order to avoid excessive slipping from occurring between the media 22 and the rollers 50 and 60. Thus, in some implementations, the level of back-tension T₂₂ applied by the motor 30 may be adjusted by the controller 40 based on the width W₂₂ of the print media 22 itself. The value of the width W₂₂ may either be measured automatically within the printer (e.g., printer 10) such as, for example, via an optical sensor disposed on the print mechanism 80, or it may be entered manually by an operator or user. In some examples, the controller 40 contains software which relates values of the width W₂₂ to corresponding values of torque Tr₂₀. Thus, once the width W₂₂ is determined via the methods described herein, the controller 40 directs the motor 30 to apply a torque load Tr₂₀ that corresponds to the value of the width W₂₂. In some examples, the values of torque Tr₂₀ which correspond to given values of the width W₂₂ are experimentally determined.

Still referring to FIGS. 2 and 3, as previously described above, in some examples, the level or amount of the torque Tr₂₀ applied by the motor 30 may be adjusted based on the amount of friction or drag within the printer (e.g., printer 10) which resists the advance of print media 22 along the direction X. More particularly, as the friction experienced by the print media 22 is increased, the amount of the torque Tr₂₀ applied to the spindle assembly 20 is reduced in order to maintain a desired level of the back-tension T₂₂. The friction experienced by the media 22 generally comprises two components—a fixed component which is associated with the inner workings and parameters of the particular printer (e.g., printer 10), and a variable component, which is associated with the mass of the spindle assembly 20. The variable amount of friction may be measured or determined in a variety of different ways while still complying with the principles disclosed herein. For example, the value of the variable component of friction may be determined by first measuring or determining the volume of the print media 22 disposed on the spindle 20a, via the controller 40. The volume may be determined from values such as radius R₂₀ of the spindle assembly 20 and the width W₂₂ of the print media 22, wherein each of these values may be determined by the methods previously described. Next, the controller 40 calculates the estimated mass of the spindle assembly 20 by multiplying the volume with the density of the print media 22 itself. In some examples, the density is supplied by the operator or user of the printer. Thereafter, the controller 40 determines the estimated value of the frictional forces opposing the advance of the print media 22 and adjusts the torque applied to the motor 30 in order to maintain a desired level of back-tension T₂₂. Specifically, in some examples, the controller 40 contains software which relates values of the mass of the spindle assembly 20 to corresponding values of torque Tr₂₀. Thus, once the mass of the spindle assembly 20a is determined via the methods described herein, the controller 40 directs the motor 30 to apply a torque load Tr₂₀ that corresponds to the value of the mass. In some examples, the values of torque Tr₂₀ which correspond to given values of the mass of the spindle assembly 20 are experimentally determined

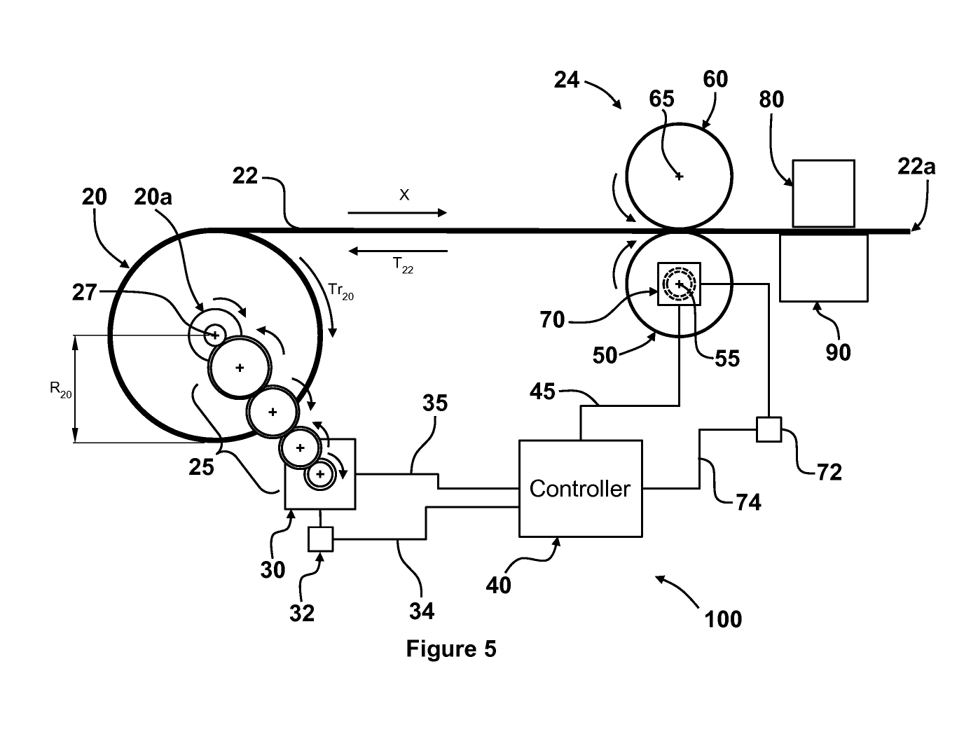

Referring now to FIG. 5, in some implementations, the torque Tr₂₂ applied by the motor 30 may be reversed in direction based on the determined value of the friction experienced by the print media in order to assist in the advancement thereof along the direction X (such as is shown in FIG. 5). In particular, if the friction within the system is found to be above or greater than the desired level of back tension T₂₂ for a given print advance, then the controller 40 may reverse the direction of the torque Tr₂₀ applied by the motor 30 such that the tension T₂₂ experienced by the media 22 is reduced, or may, in some examples, be replaced by a compressive force (which acts along the direction X).

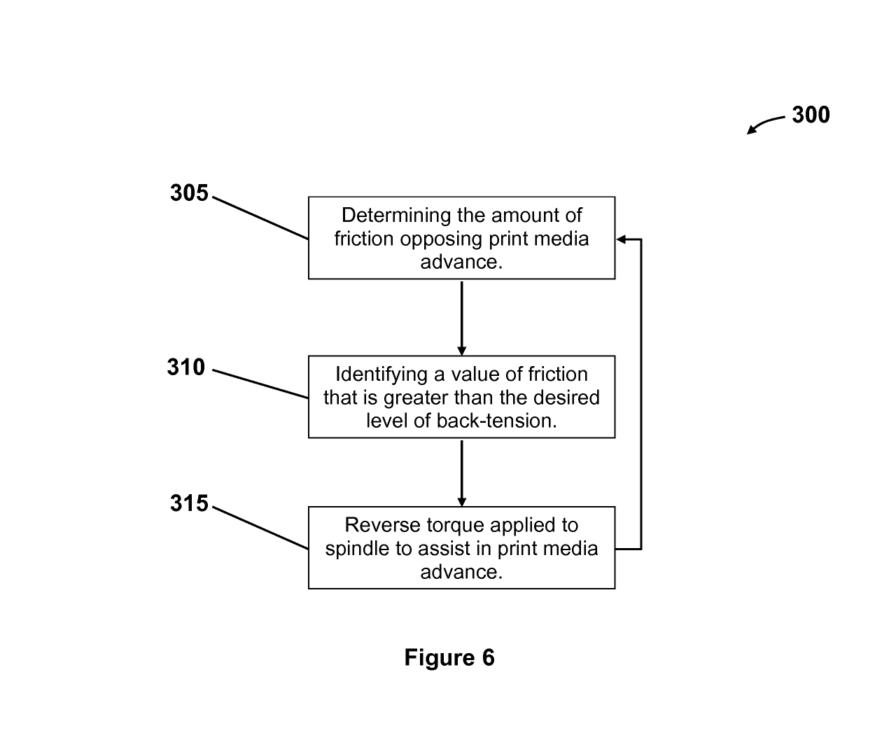

Referring now to FIG. 6, wherein a method 300 for assisting in a print media advance is shown. Though depicted sequentially as a matter of convenience, at least some of the operations shown can be performed in a different order and/or performed in parallel. Further, some embodiments may perform only some of the operations shown. Still further, in some example, the method 300 may be performed largely by the controller 40.

Initially, the amount of friction within the printer (e.g., printer 10) which opposes or resists the advancement of print media (e.g., print media 22) is determined at block 305. This value of friction may be determined, for example, by methods previously described above. Next, the amount of friction is compared to the desired level of back-tension (e.g., tension T₂₂) for the print advance taking place such that a determination is made that the friction is greater than the desired amount of back-tension at block 310. Finally, the torque (e.g., Torque Tr₂₀) applied to the spindle (e.g., spindle assembly 20) is reversed due to the determination made in block 310 such that print media 22 advance is assisted.

Referring again to FIGS. 2 and 3, in some examples, skew within the print media 22 is automatically detected upon loading of the print media 22 within the printer (e.g., printer 10). Specifically, a sensor (not shown) mounted within the printer senses the leading edge 22a of the print media 22. Thereafter, the sensor is moved along the width W₂₂ of the print media 22 in order to sense the location of the leading edge 22a at several locations. If media skew is detected, via the measurements of the sensor, then a series of print media moves are initiated both along with and opposite to the direction X. During these print moves, the torque Tr₂₀ applied by the motor 30 is adjusted such that a relatively high level of back-tension T₂₂ is applied to the print media 22 to correct the measured skew. The print moves are repeated until the skew is eliminated or reduced to an acceptable as measured by the sensor. Thereafter, the print media 22 is advanced via normal printing operations. In some examples, the sensor may be an optical sensor. Further, in some examples, the sensor may be mounted to the print mechanism 80.

While the examples described and shown herein show the encoders 32 and 72 as being separate components from the motors 30 and 70 respectively, in other examples, the encoders 32 and 72 may be integrally formed with the motors 30 and 70 respectively. Additionally, some examples of the system 100 shown herein do not include an encoder 72 while still complying with the principles disclosed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a roll media print mechanism;
a roll media spindle to hold a roll of print media thereon; and
a servo motor coupled to the roll media spindle;
wherein the servo motor is to apply a first level of back-tension on the print media during a media advance that is not associated with printing and wherein the servo motor is to apply a second level of back-tension on a print media during a media advance that is associated with printing; and
wherein the first level of back tension is greater than the second level of back-tension.

2. The system of claim 1, wherein the first level of back-tension is approximately six times the second level of back-tension.

3. The system of claim 1, wherein the servo motor is coupled to the roll media spindle via a gear train.

4. The system of claim 1, further comprising a controller, wherein the controller is to adjust the level of back-tension based on the mass of the roll of print media disposed on the roll media spindle.

5. The system of claim 4, wherein the controller is to assist in a print media advance based on the mass of the roll of print media.

6. The system of claim 4, wherein the controller is to adjust the level of back-tension based on the width of the print media.

7. The system of claim 4, wherein the controller is to adjust the level of back-tension based on the radius of the roll of print media.

8. The system of claim 1, further comprising a sensor to sense a location of a leading edge of the print media and generate an output signal, wherein the servo motor is to adjust the level of back-tension applied to the print media based on the signal of the sensor.

9. A method, comprising:
decreasing a back-tension on a print media while advancing the print media for printing; and
increasing the back-tension on the print media while advancing the print media for purposes other than printing.

10. The method of claim 9, wherein decreasing the back-tension comprises reducing the torque applied to a roll media spindle by a servo motor; and wherein increasing the back-tension comprises increasing the torque applied to the roll media spindle by the servo motor.

11. The method of 10, wherein increasing the back-tension comprises increasing the back-tension to six times the level of back-tension applied while advancing the print media for printing.

12. The method of claim 9, further comprising adjusting a level of back-tension on the print media based on the width of the print media.

13. The method of claim 9, further comprising adjusting a level of back-tension on the print media based on the radius of the roll of print media.

14. The method of claim 9, further comprising adjusting a level of back-tension on the print media based on the weight of the roll of print media.

15. A system, comprising:
a roll media print mechanism;
a feed roller;
a roll media spindle to hold a roll of print media thereon;
a first servo motor to apply a torque to the feed roller;
a second servo motor to apply a torque to the roll media spindle; and
a controller coupled to the first and second servo motors, wherein the controller is to adjust the torque of the second servo motor based on the mass of the roll media spindle.

16. The system of claim 15, wherein the controller is to adjust the torque of the second servo motor to apply a compressive force to the print media.

17. The system of claim 15, wherein the controller is to apply a first level of torque to the roll media spindle via the second servo motor during a print advance that is not associated with printing, and wherein the controller is to apply a second level of torque to the roll media spindle via the second servo motor during a print advance that is associated with printing.

18. The system of claim 17, wherein the first level of torque is higher than the second level of torque.

19. The system of claim 15, wherein the controller is to adjust the torque of the second servo motor based on a radius of the roll media spindle.

20. The system of claim 15, wherein the controller is to adjust the torque of the second servo motor based on a width of the roll of print media.
